(19) United States
(12) Patent Application Publication
(10) Pub. No.: US 2010/0165142 A1
(43) Pub. Date: Jul. 1, 2010

(54) ELECTRONIC DEVICE AND WHITE BALANCE ADJUSTMENT METHOD FOR THE ELECTRONIC DEVICE

(75) Inventor: HAI-ZHOU WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/578,682

(22) Filed: Oct. 14, 2009

(30) Foreign Application Priority Data
Dec. 26, 2008 (CN) 200810306567.6

(51) Int. Cl. H04N 9/73

(52) U.S. Cl. 348/223.1; 348/E09.051

(57) ABSTRACT

An electronic device and a white balance adjustment method for the electronic device installed with a camera unit are provided. The camera unit is installed with a light sensor and a digital signal processor (DSP). The light sensor senses light that strikes the electronic device, to determine a source of the light, and acquires illumination parameters of the light source. The DSP adjusts white balance settings of the camera unit according to the illumination parameters, and converts an image of an object captured by a charge coupled device into a user recognizable image. The user recognizable image is displayed on a display device of the electronic device.

### BACKGROUND

1. Technical Field

Embodiments of the present disclosure generally relate to an electronic device, and more particularly to a white balance adjustment method for the electronic device.

2. Description of Related Art

In general, color temperature measurements are used for white balance adjustments. However, camera units using color temperature measurements may not accurately adjust white balance and produce reddish or bluish images.

What is needed, therefore, is a white balance adjustment method for an electronic device which can use a light sensor to sense light source types, so as to more accurately adjust the white balance of a camera unit of the electronic device.

### BRIEF DESCRIPTION OF THE DRAWINGS

FIG. 1 is a block diagram of one embodiment of an electronic device for adjusting white balance.

FIG. 2 is a block diagram of function modules of a digital signal processor included in the electronic device of FIG. 1.

FIG. 3 is a flowchart illustrating one embodiment of a white balance adjustment method for the electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

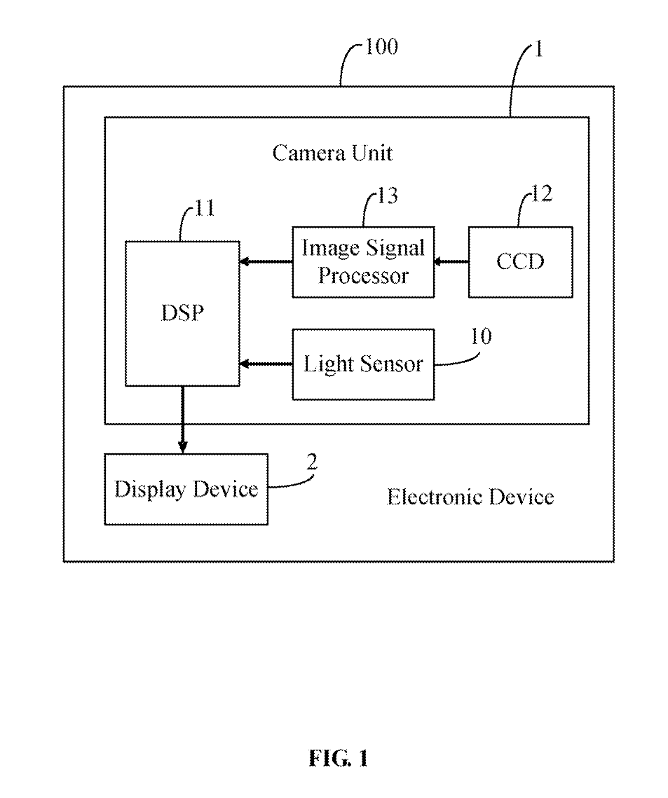

FIG. 1 is a block diagram of one embodiment of an electronic device for adjusting white balance. The electronic device 100 may be a mobile phone, a personal digital assistant, a personal computer or a game machine that is installed with a camera unit 1 and a display device 2. The camera unit 1 of the electronic device 100 typically includes a light sensor 10, a digital signal processor (DSP) 11, a charge coupled device (CCD) 12, and an image signal processor (ISP) 13.

The light sensor 10 connects to the DSP 11, and is operable to sense light that strikes the electronic device 100, to determine a source of the light. In the embodiment, the light source may be an incandescent lamp, a fluorescent lamp, or sunlight, for example. The light sensor 10 further acquires illumination parameters of the light source. In the embodiment, the illumination parameter may include a light intensity and RGB values of the light source.

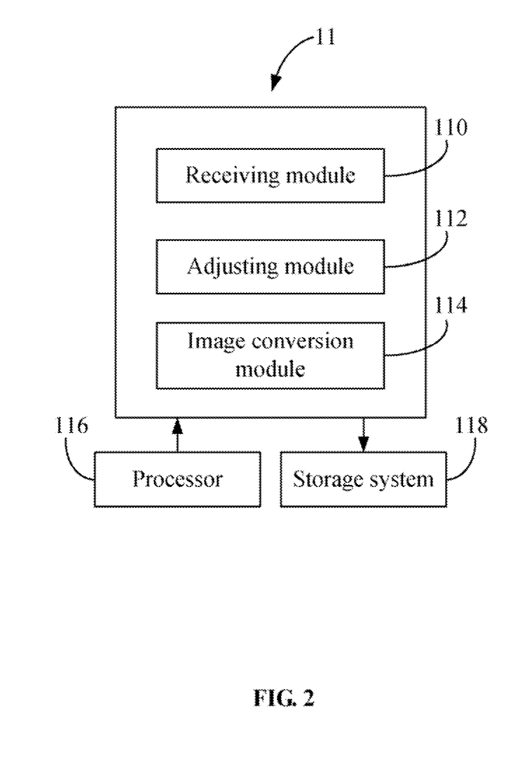

The DSP 11 is operable to adjust white balance settings of the camera unit 1 according to the illumination parameters. As shown in FIG. 2, the DSP 11 may include at least one processor 116, a storage system 118, and a plurality of instructions stored in the storage system 118. In one embodiment, the storage system 118 may be a random access memory (RAM) for temporary storage of information and/or a read only memory (ROM) for permanent storage of information. The storage system 118 may also be a hard disk drive, a compact disc, a digital video disc, a tape drive, or some combination of various digital storage systems. The DSP 11 may further include a receiving module 110, an adjusting module 112 and an image conversion module 114, that can be executed by the at least one processor 116.

The receiving module 110 receives the illumination parameters of the light source acquired by the light sensor 10. The adjusting module 112 adjusts brightness and contrast of the camera unit 1 according to the illumination parameters, and adjusts RGB settings (includes a “R” value, a “G” value, and a “B” value) of the camera unit 1 to comply with the RGB values of the light source. For example, the adjusting module 112 can multiply or divide each of the “R” value, the “G” value and the “B” value of the RGB setting with, for example, an amplifier or divider circuit.

When the CCD 12 is controlled to capture an image of an object, the ISP 13 is operable to convert the image into a digital image, and transmit the digital image to the DSP 11. The image conversion module 114 converts the digital image into a user recognizable image.

In the embodiment, the user recognizable image can be displayed on the display device 2 of the electronic device 100.

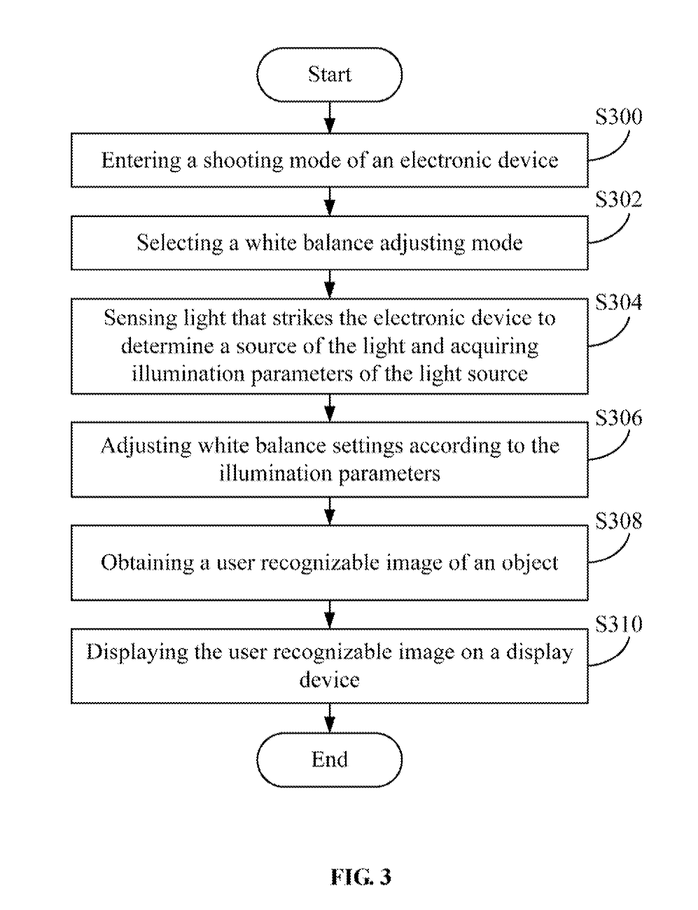

FIG. 3 is a flowchart illustrating one embodiment of a white balance adjustment method for the electronic device 100. Depending on the embodiment, additional blocks in the flow of FIG. 3 may be added, others removed, and the ordering of the blocks may be changed.

In block S300, a shooting mode of the electronic device 100 is entered when a user clicks an item related to the shooting mode. For example, if the user wants to shoot an object, a shooting item may be clicked to enter the shooting mode.

In block S302, the user selects a white balance adjusting mode for adjusting white balance settings of a camera unit 1 of the electronic device 100.

In block S304, the light sensor 10 senses light that strikes the electronic device 100, to determine a source of the light, and acquires illumination parameters of the light source. In the embodiment, the illumination parameters include a light intensity and RGB values of the light source. For example, the RGB values of the light source may be: R=88, G=76 and B=62. In one embodiment, the camera unit 1 has a default setting RGB values, such as R=50, G=50 and B=50. The light source may be an incandescent lamp, a fluorescent lamp, or sunlight, for example.

In block S306, the receiving module 110 receives the illumination parameters, the adjusting module 112 adjusts white balance settings of the camera unit 1 according to the illumination parameters. In the embodiment, the white balance adjustment includes adjusting brightness and contrast of the camera unit 1, and adjusting RGB settings of the camera unit 1 to comply with the RGB values of the light source. For example, the adjusting module 112 adjusts the RGB settings of the camera unit 1 to: R=88, G=76 and B=62.

In block S308, the user may press a button to control the CCD 12 to obtain a user recognizable image of the object. In details, the CCD 12 is controlled to capture an image of the object. The ISP 13 converts the image into a digital image, and then transmits the digital image to the DSP 11. The image conversion module 114 converts the digital image into the user recognizable image.

In block S310, the display device 2 displays the user recognizable image.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A white balance adjustment method for an electronic device installed with a camera unit, the method comprising:
sensing light that strikes the electronic device, to determine a source of the light by using a light sensor of the camera unit;
acquiring illumination parameters of the light source, the illumination parameters comprising RGB values of the light source;
adjusting white balance settings of the camera unit by changing RGB settings of the camera unit to the RGB values of the light source;
obtaining a user recognizable image of an object by using a charge coupled device of the camera unit; and
displaying the user recognizable image on a display device of the electronic device.

2. The method as described in claim 1, wherein the illumination parameters further comprise a light intensity of the light source.

3. The method as described in claim 2, wherein the adjusting block further comprises:
adjusting brightness and contrast of the camera unit.

4. The method as described in claim 1, wherein the camera unit further comprises an image signal processor and a digital signal processor.

5. The method as described in claim 4, wherein the obtaining block comprises:
controlling the charge coupled device to capture an image of the object;
converting the image into a digital image by the image signal processor; and
converting the digital image into the user recognizable image by the digital signal processor.

6. The method as described in claim 1, wherein the electronic device is a mobile phone, a personal digital assistant, a camera or a video camera.

7. An electronic device, comprising:
a camera unit and a display device, the camera unit comprising:
a light sensor operable to sense light that strikes the electronic device, to determine a source of the light, and acquire illumination parameters of the light source, the illumination parameters comprising RGB values of the light source;
a digital signal processor connected with the light sensor, the digital signal processor operable to adjust white balance settings of the camera unit by changing RGB settings of the camera unit to the RGB values of the light source;
a charge coupled device connected with the digital signal processor, the charge coupled device is controlled to capture an image of an object;
an image signal processor connected with the charge coupled device, the image signal processor operable to convert the image into a digital image, and transmit the digital image to the digital signal processor;
the digital signal processor further operable to convert the digital image into a user recognizable image of the object; and
the display device operable to display the user recognizable image.

8. The electronic device as described in claim 7, wherein the illumination parameters further comprise a light intensity of the light source.

9. The electronic device as described in claim 8, wherein the digital signal processor comprises:
a receiving module operable to receive the illumination parameters of the light source acquired by the light sensor;
an adjusting module operable to adjust brightness and contrast of the camera unit according to the illumination parameters, and change the RGB settings of the camera unit to comply with the RGB values of the light source; and
an image conversion module operable to convert the digital image into the user recognizable image.

10. The electronic device as described in claim 7, wherein the electronic device is a mobile phone, a personal digital assistant, a camera or a video camera.

11. A storage medium having stored thereon instructions that, when executed by a processor of an electronic device, cause the processor to implement a white balance adjustment method for the electronic device installed with a camera unit, the method comprising:
receiving a light source through a light sensor of the camera unit sensing light that strikes the electronic device;
receiving illumination parameters of the light source acquired by the light sensor, the illumination parameters comprising RGB values of the light source;
adjusting white balance settings of the camera unit by changing RGB settings of the camera unit to the RGB values of the light source;
obtaining a user recognizable image of an object by using a charge coupled device of the camera unit; and
displaying the user recognizable image on a display device of the electronic device.

12. The storage medium as claimed in claim 11, wherein the illumination parameters further comprise a light intensity of the light source.

13. The storage medium as claimed in claim 12, wherein the adjusting block further comprises:
adjusting brightness and contrast of the camera unit.

14. The storage medium as claimed in claim 11, wherein the camera unit further comprises an image signal processor and a digital signal processor.

15. The storage medium as claimed in claim 14, wherein the obtaining block comprises:
controlling the charge coupled device to capture an image of the object;
converting the image into a digital image by the image signal processor; and
converting the digital image into the user recognizable image by the digital signal processor.
